(19) United States
(12) Patent Application Publication
(10) Pub. No.: US 2006/0034433 A1
(43) Pub. Date: Feb. 16, 2006

(54) Arrangement with a telecommunications apparatus and a data processing system for standardized absence notification

(75) Inventor: Jurgen Landsperger, Stadtbergen (DE)

Correspondence Address: COHEN, PONTANI, LIEBERMAN & PAVANE, Suite 1210, 551 Fifth Avenue, New York, NY, 10176, US

(73) Assignee: Fujitsu Siemens Computers GmbH, Munich (DE)

(21) Appl. No.: 11/197,962

(22) Filed: Aug. 4, 2005

(30) Foreign Application Priority Data
Aug. 4, 2004 (DE) 10 2004 037 861.4

(51) Int. Cl. H04M 11/00

(52) U.S. Cl. 379/93.06; 379/90.01

(57) ABSTRACT

An arrangement comprising a telecommunications apparatus (1) and a data processing system (2) for providing an e-mail function, wherein the telecommunications apparatus (1) and the data processing system (2) each have a user-specific absence assistant (3, 4). The telecommunications apparatus (1) and the data processing system (2) are linked together by a data transmitting link (15) and are equipped so that by activating one of the absence assistants (3, 4) the other absence assistant (4, 3) is automatically activated.

### RELATED APPLICATION

This patent application claims the priority of German patent application 10 2004 037 861.4, filed Aug. 4, 2004, the disclosure content of which is hereby incorporated by reference.

### FIELD OF THE INVENTION

This invention relates to an arrangement with a telecommunications apparatus and a data processing system for providing an e-mail function, whereby the telecommunications apparatus and the data processing system each have a user-specific absence assistant.

### BACKGROUND OF THE INVENTION

The usual office workplaces are equipped with both a telecommunications apparatus and a data processing system. The telecommunications apparatus is used for voice communication while the data processing system is used for communication by e-mail, for example. Modern telecommunications apparatus is also equipped with PC interfaces so that, for example, the telephone number of a conversation partner to be called can be selected from an address program managed by the data processing system and then the telecommunications apparatus will automatically dial the desired number.

One thing in common in communication by telephone and communication by e-mail is that a caller or a sender of e-mail reaches the desired communication partner only when the latter is at his workplace. The telecommunications apparatus and the data processing system therefore frequently offer the option of leaving the caller or sender of e-mail a message notifying the caller, for example, that the desired communication partner is not present and when he might return. Programs for handling e-mail traffic are frequently set up for sending a so-called absence message when the recipient is not present. In this case, the user enters a message in advance which is sent as return mail to the sender of e-mail. For example, the sender of e-mail is informed that his e-mail cannot be processed and when he can expect an answer at the soonest. Such functions are generally referred to below as absence assistants. They include, among other things, an opportunity to automatically reply to phone calls or e-mail.

Despite coupling of a telecommunications apparatus with a data processing system, it is relatively complex to store absence messages everywhere and activate the respective absence assistants. This often results in a caller or sender of e-mail not being informed of the absence of the desired communication partner.

### SUMMARY OF THE INVENTION

One object of this invention is to provide an arrangement with a telecommunications apparatus and a data processing system that will eliminate the problems mentioned above.

This and other objects are attained in accordance with one aspect of the present invention directed to an arrangement comprising a telecommunications apparatus and a data processing system for providing an e-mail function, wherein the telecommunications apparatus and the data processing system include respective user-specific absence assistants. A data connection is provided for linking the telecommunications apparatus and the data processing system to each other. A means is provided for responding to activation of one of the absence assistants by automatically activating another of the absence assistants over the data transmitting link.

Activation of the absence assistant of the data processing system may trigger activation of the absence assistant of the telecommunications apparatus. Activation of the absence assistant of the telecommunications apparatus may trigger activation of the absence assistant of the data processing system. Of course, the two approaches may also be combined leading to the same result regardless of whether the absence assistant of the telecommunications apparatus or the absence assistant of the data processing system is activated first.

An embodiment of the invention involves a device for personal monitoring, to monitor when a person leaves and enters the spatial area of the arrangement. On leaving the spatial area, the absence assistants are automatically activated, whereas they are automatically deactivated on entering the room area.

Another embodiment of the invention enables both absence assistants to access a common message. It is advantageous here for a written text to be stored in the data processing system so that this text can be read out by a “computer voice.”

### BRIEF DESCRIPTION OF THE DRAWINGS

FIG. 1 shows a first exemplary embodiment of an inventive arrangement.

FIG. 2 shows a second exemplary embodiment of an inventive arrangement having a central memory.

FIG. 3 shows a third exemplary embodiment of an inventive arrangement having a personal monitoring device and

FIG. 4 shows a fourth exemplary embodiment of an inventive arrangement having a wireless LAN device.

### DETAILED DESCRIPTION OF THE DRAWINGS

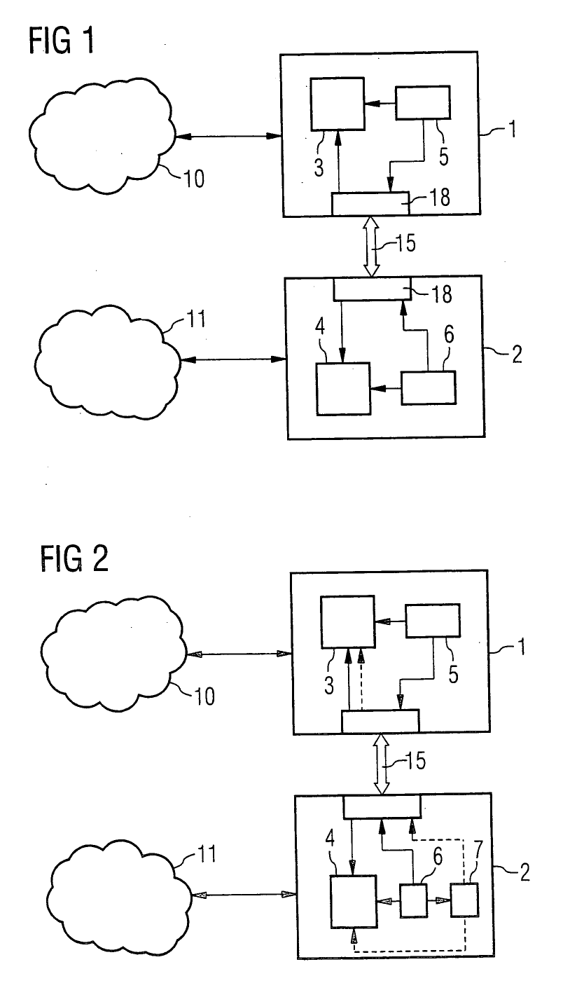

FIG. 1 shows an arrangement with a telecommunications apparatus 1 and a data processing system 2. The telecommunications apparatus 1 is connected to a private or public telephone network 10, while the data processing system 2 is connected to a computer network 11, e.g., the Internet.

The telecommunications apparatus 1 has a user-specific call answering function as the absence assistant 3. When the absence assistant 3 is deactivated, incoming calls are accepted directly by the user. When the absence assistant is activated, an incoming call is automatically answered, then an announcement text is read and the caller is given the option of leaving a message. The announcement text frequently includes information about when the user being called can be reached again.

Use of an absence assistant in a telephone system has long been known and its implementation in connection with the present invention is readily apparent to a person with ordinary skill in the art. An example of this feature can be found in the Siemens HiPath 500—Gigaset Professional telephone system.

Before activating the absence assistant 3, it must be instructed regarding which announcement text is to be output, i.e., in particular when the user will be available again. To do so, input means 5 are provided, including means for voice input, for example, and also offering the possibility of activating or deactivating the absence assistant 3 of the telecommunications apparatus 1.

The schematic diagram in FIG. 1 shows the telecommunications apparatus 1 as a block, which also includes telecommunications apparatus implemented as distributed systems. A user has access to a terminal set up at a place of work, for example. The terminal is connected to a central communications system which is responsible for interdepartmental telephone communications on the one hand while on the other hand also forming an interface to a public telephone network. The user-specific absence assistant may be implemented either in the terminal or in the central communications system.

The data processing system 2 also has an absence assistant 4 which implements an automatic e-mail answering function. The data processing system 2 has an e-mail function, i.e., it can receive e-mail from the computer network 11 and a user of the data processing system 2 can send an e-mail to a recipient that can be reached via the computer network 11. When the automatic e-mail answering function is deactivated, the received e-mail is stored and a user can process it further as desired. When the e-mail answering function is activated, in addition to storing the message, a preselected response text is sent back to the sender of an incoming e-mail. This response text usually includes the message that the desired recipient is not present at the moment but will return on a certain date. Then the sender of the e-mail knows that his message is not currently being processed and also when he can expect it to be handled at the soonest.

Use of an absence assistant in an email system is known, for example, from the MS Office software. Such email absence assistants have been known and used for quite some time, and its implementation in connection with the present invention is readily apparent to a person with ordinary skill in the art.

The data processing system 2 has input means 6 with which the response text to be sent can be specified and which permit activation or deactivation of the response assistant 4.

The data processing system 2 is shown as a block in the schematic diagram in FIG. 1. However, it need not be a single computer but may instead also be a server that is connected to a workstation computer. If a user is absent, his workstation computer will usually also be turned off so that he cannot provide an automatic e-mail answering function. Instead, it is implemented in a mail server which provides the users registered there with the desired e-mail answering function. However, the input means 6 may be assigned to a workstation computer.

The data processing system 2 is connected to the telecommunications apparatus 1 via a data connection 15 so that the data processing system 2 and the telecommunications apparatus 1 have suitable interfaces 18.

An enhancement of the prior art in accordance with the present invention includes modifying the above-discussed arrangement so that activation of the call answering function of the telecommunications apparatus 1, for example, triggers activation of the automatic e-mail answering function or vice-versa. A user therefore need no longer think about activating the absence assistants 3 and 4 of the two devices before leaving his workstation, but instead it is sufficient to merely activate one absence assistant. The other absence assistant is then activated automatically. More specifically, the system includes means to determine when any one of several absence assistants available on the system is activated. Upon such a determination being made, the system automatically responds by triggering activation of the other absence assistants so that they all are in an active status together. The implementation of this feature is via software using hardware components which are available “off-the-shelf”. Following revelation of the present invention, implementation of this feature would be readily apparent to any person with ordinary skill in the art.

A user has an opportunity to control whether or not the other absence assistants should also be automatically activated. This is appropriate in particular when the user is absent for only a short period of time, e.g., to participate in a meeting. Since then the user is temporarily not available to answer incoming telephone calls, the absence assistant of the telecommunications apparatus 1 should be activated. However, an immediate response to an incoming e-mail is not expected by senders of e-mail, so that activation of the absence assistant 4 of the data processing system 2 under such circumstances (e.g., a brief absence) is not necessary. A user interface is provided to enable the user to select whether or not the other absence assistants are to be automatically activated. The implementation of such a user interface would be readily apparent to a person with ordinary skill in the art.

FIG. 2 shows an expanded exemplary embodiment of an inventive arrangement in which a memory 7 is provided in the data processing system 2 such that the two absence assistants 3 and 4 can access this memory. It is advantageous here that only one response text must be entered, which has been sent by the absence assistant 4 of the data processing system 2 to a sender of e-mail in text form and is used as an announcement text in a voice form when read out by the absence assistant 3 of the telecommunications apparatus. The reading of a message stored in text form by a “computer voice” is a problem that can be solved easily from a technical point of view and a voice quality fully adequate for the purpose of conveying information can be achieved.

In the simplest case, the message to be stored in the memory 7 is generated by the input means 6 because it is suitable for text input, as described above. For activation of the absence assistants 3 and 4, it does not matter whether this is accomplished via the telecommunications apparatus 1 or the data processing system 2.

The absence message may be generated automatically with the assistance of the data processing system 2. The user need only indicate when he will be available again. An absence message with the contents such as “Mr. Meier will not be available until Feb. 29, 2008 and will contact you after he returns” can be created automatically. For a short-term absence, completely automatic creation of messages is possible by using the date of the next work day as the date of return. In the case of automatic creation of messages, it is especially advantageous for this to also be performed from a remote computer. For example, if a business trip is extended, the user can update the date of his return via an Internet interface. The implementation of this feature is readily apparent to a person with ordinary skill in the art, and an example is the above-mentioned Siemens HiPath 500 telephone system.

The telecommunications apparatus 1 receives the text from the data processing system 2 in the manner described here so that even a caller by telephone will hear an updated message text read out.

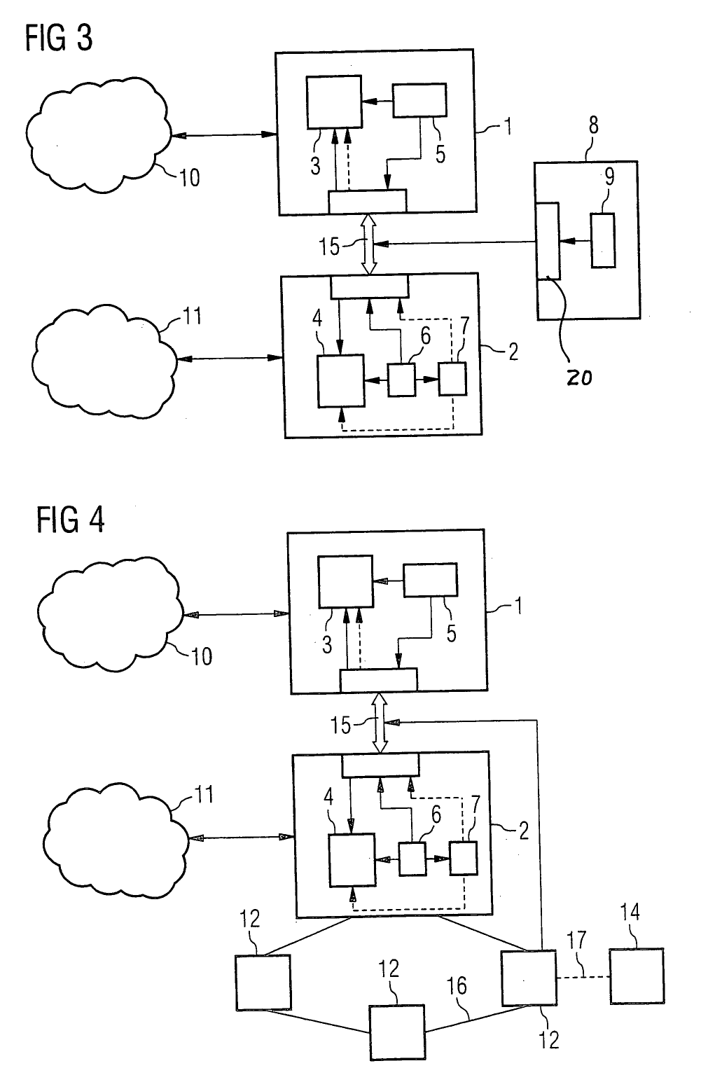

In the exemplary embodiment in FIG. 3, an additional personal monitoring device 8 is provided. Such personal monitoring devices are provided, for example, at the guard house of company premises to be sure that only authorized persons enter the premises. This also makes it possible to determine the time when employees are present.

When an employee leaves the company premises, he is no longer able to receive a call at his workplace or reply to e-mail. The personal monitoring device 8 is therefore equipped to activate the absence assistants 3 or 4 of the telecommunications apparatus 1 or the data processing system 2 by using corresponding means 9 and a data connection 20 when an employee leaves the premises. It may be expedient to configure the arrangement in such a way that only the absence assistant 3 of the telecommunications apparatus 1 is activated on leaving the company premises, whereas the absence assistant 4 of the data processing system 2 remains deactivated. As explained above, an immediate response to e-mails is not expected, so that on leaving the company premises for a short period of time, e.g., until the next work day, it is not necessary to send absence notices.

It is of course also possible for an automatic deactivation of the absence assistants 3 and 4 to be performed by the personal monitoring device 8 on entering the company premises.

The exemplary embodiment in FIG. 4 illustrates another possibility of triggering automatic activation or deactivation of the absence assistants 3 and 4. With the arrangement shown here, a local computer network 16 is provided, also referred to as a LAN (Local Area Network) for interconnecting computers 12. The LAN 16 is also connected to the data processing system 2 which has the absence assistant 4. The LAN 16 has nodes 14, e.g., a pocket computer which is connected by a wireless connection 17 to the LAN 16. With this technology which is known as WLAN (Wireless Local Area Network) the devices thereby connected are active as participants in the LAN 16 as long as they are within the range of WLAN stations. The range is optimally such that a good connection on company premises is ensured, but for safety reasons the range does not go beyond that. When an employee leaves the company premises to take a trip or go home, in any case he goes out of the range of the wireless LAN. The LAN 16 recognizes that a wireless LAN device carried by the employee is exiting from the network association. It can therefore be concluded from leaving the network association that the user will not be able to receive a call or respond to incoming e-mail. The absence assistants 3 and 4 are therefore activated upon the employee's wireless LAN device exiting from the network association. Conversely, the absence assistants 3 and 4 can be deactivated when the wireless LAN device re-enters the company network.

The arrangements illustrated in FIG. 4 can be used appropriately when there is no personal monitoring device according to FIG. 3.

In addition to the absence functions described here, other convenience functions may of course also be implemented. For example, in the absence of a user, an absence message is sent to the sender of an e-mail and at the same time the incoming e-mail is forwarded to the user on a cell phone or to a PDA with a GSM module, e.g., via GPRS. Automatic call forwarding to a cell phone is of course also possible.

In the meantime, making telephone calls via a data network with an IP protocol has become widespread. With this so-called IP telephone system, a telephone in the traditional sense is not necessary, but calls are made instead via a module connected to a workstation computer. When using such a telecommunications apparatus which also falls within the scope of this invention, the absence assistant could be activated and deactivated respectively by inserting a chip card into a reader assigned to the workstation and pulling it out, respectively.

The scope of protection of the invention is not limited to the examples given hereinabove. The invention is embodied in each novel characteristic and each combination of characteristics, which includes every combination of any features which are stated in the claims, even if this combination of features is not explicitly stated in the claims.

I claim:

1. An arrangement comprising:
a telecommunications apparatus (1);
a data processing system (2) for providing an e-mail function;
wherein the telecommunications apparatus (1) and the data processing system (2) include respective user-specific absence assistants (3, 4);
a data connection (15) for linking the telecommunications apparatus (1) and the data processing system (2) to each other; and
means for responding to activation of one of said absence assistants by automatically activating another of said absence assistants (4, 3) over said data transmitting link (15).

2. The arrangement according to claim 1, further comprising:
a memory (7) for storing a response text, whereby the telecommunications apparatus (1) and the data processing system (2) access the memory (7) for read-out of a response text to be output on activation.

3. The arrangement according to claim 2, wherein the response texts for the telecommunications apparatus (1) and the data processing system (2) are uniform.

4. The arrangement according to claim 2, further comprising:
means for automatically creating a response text from preselected time data that are provided.

5. The arrangement according to claim 1, further comprising:
a personal monitoring device (8) to detect that a user has left a specified spatial area so that activation of at least one absence assistant (3, 4) is triggered.

6. The arrangement according to claim 1, further comprising:
a personal monitoring device (8) to detect that a user has entered a specified spatial area so that deactivation of the absence assistant is triggered.

7. The arrangement according to claim 1, further comprising:
a wireless local network (17), and means for detecting termination of a network connection to a portable communications terminal assigned to a user so that it triggers activation of at least one absence assistant.
